(19) United States
(12) Patent Application Publication
(10) Pub. No.: US 2003/0120911 A1
(43) Pub. Date: Jun. 26, 2003

(54) Method of reprogramming modules

(76) Inventors: Stephen L. Muench-Casanova, Rochester, MI (US); Rajiv Saxena, Crystal Lake, IL (US); Kevin J. White, Utica, MI (US); Jeffrey C. Vogel, Troy, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/034,215

(22) Filed: Dec. 20, 2001

(51) Int. Cl. G06F 15/177

(52) U.S. Cl. 713/2

(57) ABSTRACT

A hybrid method of reprogramming the memory of an electronic module initializes the module and prepares it for the capability to subsequently receive information via high speed wireless transmission by initially down-loading to the module memory via a relatively low speed wire bus, a boot loader program and an operating system kernel. Subsequently, the remaining module memory is reprogrammed, or flashed by wirelessly transmitting new memory information in accordance with wireless protocol information passed to the module by the wire bus.

### BACKGROUND OF THE INVENTION

The invention pertains to reprogramming or “flashing” of the memory of electronic modules. More particularly, the invention concerns flashing or reprogramming increasingly larger modern-day application and program data in a time period sufficient for the flashing or reprogramming operation to be compatible with a relatively high-speed assembly line for units, such as automobiles, containing such electronic modules.

Programmable electronic modules are finding extremely rapidly increasing rates of use in units typically assembled along an assembly line, such as automotive vehicles. With application and program code for such modules growing at the current rate, it has been found that a more efficient method of module flashing, or reprogramming, will be required to prevent unacceptable slowdowns or stoppages of an assembly line of vehicles which are to incorporate such electronic modules.

For example, when using a relatively slow speed serial hard wired vehicle communication bus, such as the J1850, a typical automotive module, such as a hands-free module, will take on the order of 13 minutes to reprogram. This required time period is incompatible with typical speeds of automotive assembly lines which limit the vehicle's positioning at a fixed assembly line station to on the order of 45 seconds to one minute.

Therefore, there is seen to be a need for a method of flashing electronic module memories with relatively large application software and program code in a relatively fast way more amenable to dwell times at typical stations along an assembly line, such as an automotive assembly line.

### SUMMARY OF THE INVENTION

Accordingly, a method of reprogramming the memory of an electronic module includes the steps of first down-loading a boot loader program and initializing software to a first portion of the module memory via a conventional wired bus to enable the module to receive information via a preselected wireless protocol; and then down-loading wirelessly new application and program software to a second portion of the module memory via the preselected wireless protocol.

In another aspect of the invention, a method of flashing the memory portion of an electronic programmable module incorporated into units on an assembly line comprises the steps of first positioning each unit at a first flashing station and down-loading a boot loader program and operating system kernel via a wired bus to the module to enable the module to receive information via a preselected wireless protocol and then positioning each unit at a second flashing station and wirelessly down-loading application and program software to the module via the preselected wireless protocol.

### BRIEF DESCRIPTION OF THE DRAWINGS

The objects and features of the invention will become apparent from a reading of a detailed description, taken in conjunction with the drawings, in which:

FIG. 1 depicts first and second memory flash stations arranged in accordance with the principles of the invention;

FIG. 2 sets forth in block diagram form pertinent portions of an electronic module being reprogrammed or flashed in accordance with the principles of the invention; and

FIG. 3 is a flow chart setting forth the steps of the method of the invention.

### DETAILED DESCRIPTION OF THE PREFERRED EMBODIMENTS

In prior assembly line applications, for example for automotive products, smaller amounts of software needed to be flashed to the memory of electronic modules included in each vehicle passing along the line. Typically, a bank of generic control modules would be positioned at a station along the assembly line. As each vehicle moves down the line, the module, such as an engine controller, would be programmed at a flashing station in accordance with that vehicle's specifications. The module would be loaded into the vehicle with a new part number in accordance with the program down-loaded.

By contrast, in an electronics plant application, one typically has full access to the module board in a manner allowing high speed flashing. Our invention is advantageous in the applications involving relatively high speed assembly of units containing the flashed module (such as an automotive vehicle) and in the servicing of such units.

As pointed out previously, in-line flashing at an assembly plant faces time constraints dictated by the desired speed of the assembly line. For example, in a typical automotive assembly plant, only 45 seconds to one minute is available at a reprogramming or flashing station for each module to be installed. Currently, however, new module programs are reaching on the order of 16 megabytes and this vastly increased size, in turn, requires on the order of 30 minutes for flashing in the conventional prior art hardwired bus approach. This timing problem is overcome through use of this invention.

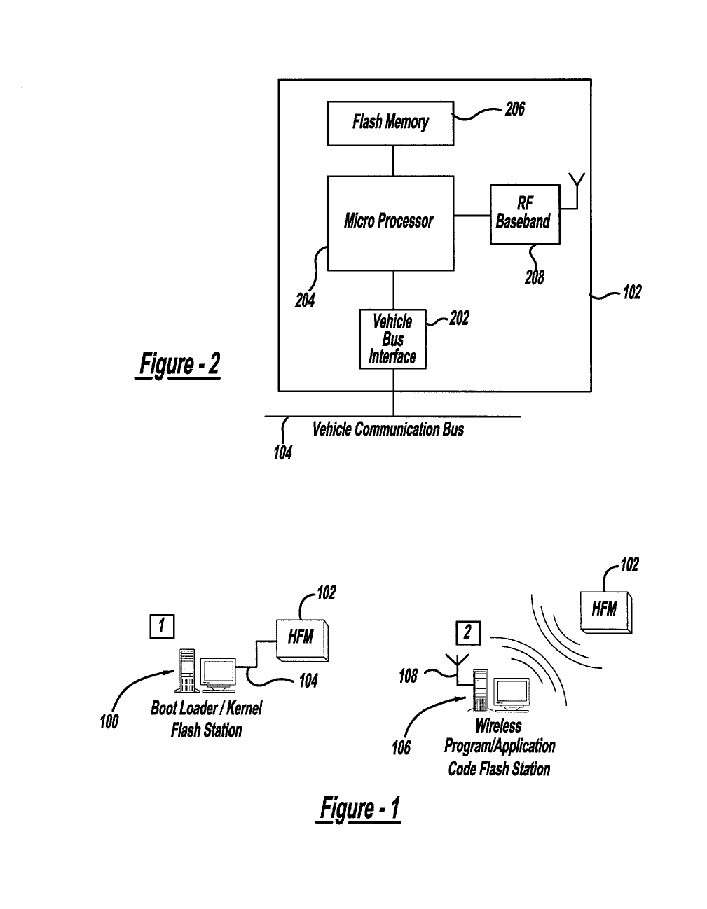

With reference to FIG. 1, a unit to be assembled, such as an automotive vehicle (not shown), incorporates a module 102 and moves along the line to a first reprogramming or flash station 100. At station 100, a hardwired bus 104 is used to down-load a boot loader program and an operating system kernel to a first portion of the module's memory. The operating system kernel is used for starting up a basic operating system on the module and for initializing the chip set on the module which implements an open system standard wireless transmission protocol, such as Bluetooth technology. This initialization of the Bluetooth chip set on the module enables the operating system to recognize what to do with information received wirelessly in accordance with the preselected protocol, such as Bluetooth.

Next, at a subsequent flashing station 106 on the line, a relatively large application and program may be down-loaded to module 102 wirelessly via transmitter 108 in accordance with the wireless protocol initially down-loaded at the previous station 100.

By using this hybrid down-loading approach at two separate flashing stations, larger applications on the order of 16 megabytes can be flashed to the module 102 in a time sufficient to enable proper maintenance of speed of the assembly line. At station 100 the down-loaded boot loader is a smaller application that the processor on the module runs on initialization and is flashed over a traditional slower hardwire bus, such as a standard automotive J1850 communication bus. Then the boot loader may launch an application to engage with a Bluetooth device. At this point at station two, the bulk of the large application code may be flashed over a wireless communication channel using the preselected wireless protocol as defined in the down-loading operation at the preceding station 100.

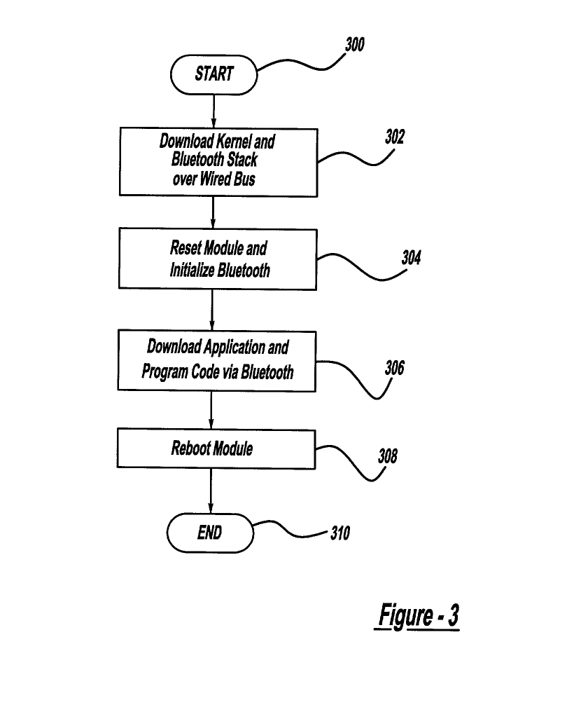

As seen from FIG. 2, each module 102 includes its own microprocessor 204, wired vehicle bus interface 202, and RF baseband circuitry 208 for wireless reception of data. The module's flash memory to be updated is shown at 206.

Preferably, to save cost, the hardwired bus 104 used to down-load the boot loader and kernel at station 100 is a vehicle communication bus already present on the vehicle being assembled. However, it is within the scope of this invention to use a totally separate hardwired bus 104, if desired.

With reference to FIG. 3, the hybrid method of reprogramming or flashing memory of electronic modules begins at block 300 and proceeds to the first down-loading step 302 wherein the kernel and the Bluetooth stack are downloaded via wired bus 104.

Next at step 304 the module is reset and the Bluetooth protocol is initialized. At step 306 the unit being assembled has moved to the next flashing station where the application and program code are down-loaded wirelessly using the previously initialized Bluetooth technology.

At step 308 the module is rebooted and the routine then ends at step 310.

The invention has been described with reference to an exemplary embodiment for the sake of example only. The scope and spirit of the invention are to be determined by appropriate interpretation of the appended claims.

What is claimed is:

1. A method of reprogramming the memory of an electronic module comprising the steps of:
down-loading a boot loader program and initializing software to a first portion of the module memory via a wired bus to enable the module to receive information via preselected wireless protocol; and
down-loading wirelessly new application and program software to a second portion of the module memory via the preselected wireless protocol.

2. The method of claim 2 wherein the preselected wireless protocol comprises an open systems standard, such as Bluetooth.

3. The method of claim 1 wherein the first portion of the module memory is smaller than the second portion.

4. The method of claim 3 wherein speed of information transmission over the wired bus is slower than speed of information transmission via the wireless protocol.

5. For use in an assembly line of units, each incorporating an electronic programmable module having flash memory, a method of flashing said memory comprising the steps of:
positioning each unit at a first flashing station and down-loading a boot loader program and operating system kernel via a wired bus to the module to enable the module to receive information via a preselected wireless protocol; and
positioning each unit at a second flashing station and wirelessly down-loading application and program software to the module via the preselected wireless protocol.

6. The method of claim 5 wherein the wired bus is incorporated into each unit.

7. The method of claim 5 wherein the preselected wireless protocol comprises an open systems standard, such as Bluetooth.
